(19) United States
(12) Patent Application Publication
(10) Pub. No.: US 2002/0144522 A1
(43) Pub. Date: Oct. 10, 2002

(54) Removal of solubilized solids from phenol-formaldehyde resin process streams

(76) Inventors: Jeffrey Messick, Indianapolis, IN (US); Syndey White, Indianapolis, IN (US); Gene Schaffstall, Dunwoody, GA (US); John E. Burns III, Indianapolis, IN (US)

Correspondence Address: Daniel L. Boots, Esq., BINGHAM SUMMERS WELSH & SPILMAN, LLP, 2700 Market Tower, 10 West Market Street, Indianapolis, IN, 46204-4900, US

(21) Appl. No.: 09/826,023

(22) Filed: Apr. 4, 2001

(51) Int. Cl. C03C 25/00

(52) U.S. Cl. 65/477

(57) ABSTRACT

A method for removing contaminants from an aqueous process stream containing ammonium ions and phenol-formaldehyde resin, such as the process stream of a fiberglass insulation manufacturer. One aspect of the method includes mixing sodium hydroxide with the aqueous stream so that the sodium hydroxide combines with the ammonium ions and liberates free ammonia. Another aspect of the method includes mixing calcium hydroxide with the aqueous stream so that the calcium hydroxide combines with the phenol-formaldehyde resin to form calcium phenate. The liberated free ammonia is captured and scrubbed, while the solid calcium phenate is easily removed by filters. The aqueous process stream is then clean enough to be reused.

The present invention relates generally to methods of removing solubilized condensation polymers from manufacturing processes streams, and more particularly to a method for removing solubilized phenol-formaldehyde resin and other solubilized contaminants from a phenol-formaldehyde binder process stream.

### BACKGROUND OF THE INVENTION

It is well known to the art to make phenol-formaldehyde resins by combining phenol with an excess of aqueous formaldehyde under basic conditions. These water-based resins are relatively inexpensive to manufacture, and find particular utility as adhesive binders, primarily in the plywood and insulation materials industries.

For example, phenol-formaldehyde resins are commonly used in the manufacture of fiberglass insulation. In that process, an aqueous binder system typically is made using about 10-30% resin, 5-10% ammonium sulfate, 5-10% urea, 1-5% silane, 1-5% ammonia, and 50-80% water.

Once the binder is made, it is transferred to a dispersal zone where it is dispersed as an aqueous spray onto molten glass fibers. The binder cools and coats the fibers, which are then collected and conveyed to an accumulator. After accumulation, the fiberglass is cured before packaging and shipment.

It is known to the art that only about 15% of the aqueous resin binder actually remains on the fiberglass through the treatment process. The remaining 85% either remains in the solution that does not adhere to the molten glass fibers, or is driven off as vapor during processing.

The largest percentage of unused resin binder remains in the “wastewater” that is formed from binder solution that does not adhere to the molten glass fibers. In the prior art, that wastewater is directed to large settling ponds where the solids are slowly removed by settling so that at least some of the water can be reused.

It is to be appreciated that tremendous amounts of water are required by the traditional process. For example, a facility making 1,500,00+pounds of fiberglass per day may require 1,290,00 gallons of water per day in that process. The settling pond removal system is therefore an unsatisfactory solution to the problem, since the size of the required ponds is vast, the removal by settling is slow and inefficient, and significant amounts of water are lost to evaporation.

A need therefore exists for a method of removing contaminants from the wastewater of a fiberglass insulation process stream so that the water can be promptly reused. The present invention addresses that need.

### SUMMARY OF THE INVENTION

Briefly describing one aspect of the present invention, there is provided a method for removing contaminants from an aqueous process stream containing solubilized ammonium ions and phenol-formaldehyde resin. One aspect of the method comprises mixing a strong base such as sodium hydroxide with the aqueous stream so that sodium ions can replace ammonium ions and liberate free ammonia. Another aspect of the method comprises mixing a salt such as calcium hydroxide with the aqueous stream so that calcium ions can combine with the phenol-formaldehyde resin to form calcium phenate. The liberated free ammonia may be captured and scrubbed, while the solid calcium phenate is easily removed by filters. The aqueous process stream is then clean enough to be reused, after adjusting the pH.

The method finds particular utility in removing solubilized solids from the process stream of a fiberglass insulation manufacturer. In that embodiment, a substantial portion of the filtered calcium phenate and other solids can be recycled to treat subsequent volumes of water. The water can then be reused as make up water for new batches of binder.

One object of the present invention is to provide a method for removing solubilized solids from the phenol-formaldehyde resin binder water of a fiberglass insulation manufacturer.

Other objects and advantages will be apparent from the following description.

### BRIEF DESCRIPTION OF THE DRAWINGS

FIG. 1 is a flow diagram of one preferred embodiment of the present invention.

FIG. 2 is a flow diagram of another preferred embodiment of the present invention, particularly the method applied to the process stream of a fiberglass insulation manufacturer.

### DESCRIPTION OF THE PREFERRED EMBODIMENTS

For the purposes of promoting an understanding of the principles of the invention, reference will now be made to certain preferred embodiments and specific language will be used to describe the same. It will nevertheless be understood that no limitation of the scope of the invention is thereby intended, such alterations and further modifications in the illustrated device, and such further applications of the principles of the invention as illustrated therein being contemplated as would normally occur to one skilled in the art to which the invention relates.

As indicated above, the present invention relates generally to methods of removing solubilized ammonia and solubilized resin from a phenol-formaldehyde resin process stream. The process finds particular utility in treating the phenol-formaldehyde resin binder water used by fiberglass insulation manufacturers.

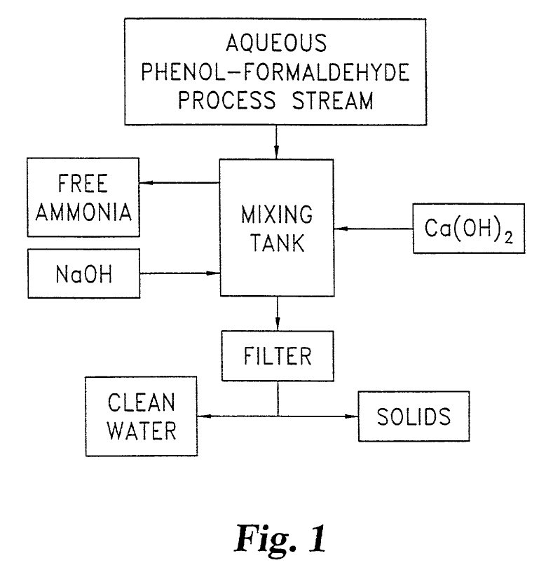

Referring now to the Figures, FIG. 1 shows a flow diagram of one preferred embodiment of the invention. As shown in that diagram, an aqueous phenol-formaldehyde process stream is combined with sodium hydroxide and calcium hydroxide in a mixing tank. The sodium hydroxide raises the pH of the aqueous stream from about 8 to about 13, and the calcium ions from the calcium hydroxide replace the hydrogen ions in the phenolic, forming insoluble calcium phenate. The phenate is easily removed by filtering.

Moreover, to the extent there is ammonium hydroxide in the process stream, the sodium hydroxide, being a much stronger base than ammonium hydroxide, replaces the ammonia in ammonium hydroxide—freeing the ammonia from solution.

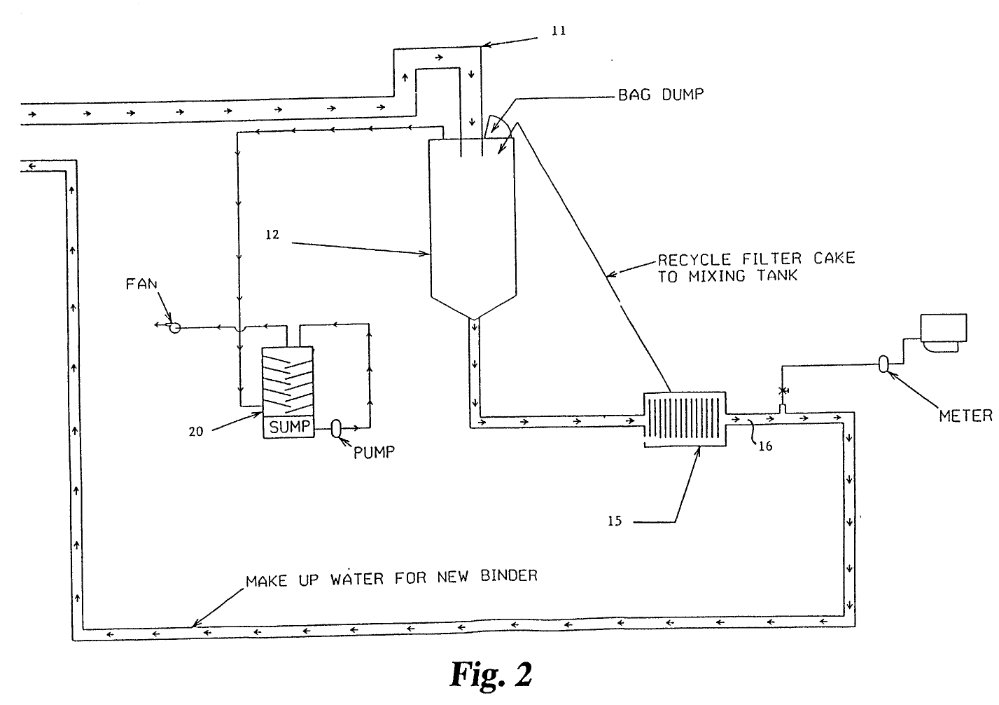

FIG. 2 shows the method of the present invention as applied to a fiberglass insulation manufacturing plant. The method begins with process stream 11, which is the aqueous phenol-formaldehyde resin binder after it has been used to coat glass fibers. As indicate above, process stream 11 typically contains solubilized resin, ammonium sulfate, urea, silane, ammonia (as ammonium hydroxide), and water. The pH of the process stream is typically in the range of about 7.5 to about 8.5. Most preferably, the process stream has been filtered to remove filterable solids such as glass, dirt, grease, etc., from the stream before chemical processing. Conventional flocculents and/or coagulants may be used to promote that solid removal.

Process stream 11 is delivered to mixing tank 12, which is closed to the atmosphere. In mixing tank 12, sodium hydroxide is combined with process stream 11. The sodium hydroxide raises the pH of the aqueous stream to about 13 (typically from about 7.5 to 8.5), and the sodium hydroxide, being a much stronger base than ammonium hydroxide, replaces the ammonium hydroxide—freeing it from solution.

The same situation occurs with the ammonia sulfate in the process stream. The sodium ion replaces the ammonia ions in water, thus freeing the ammonia from the solution. At a pH of about 13, the highly alkaline solution releases the ammonia. In the most preferred embodiments the liberated ammonia, as well as some ammonium sulfate, is then passed to acid scrubber 20.

In a like manner, urea present in the process stream is converted into ammonia and carbon dioxide in the high-pH solution. The ammonia is scrubbed as described below, while the CO₂ may be vented to the atmosphere.

In scrubber 20 the ammonia is bubbled through an acid such as NaHSO₄. As is known to the art, bubbling ammonia gas through an acid scrubber forms a solid, non-hazardous residual (ammonium sulfate), which can be landfilled. The NaHSO₄ solution can be recycled, and the air can be released to the plant atmosphere.

Also in mixing tank 12, a salt such as calcium hydroxide is added to the process stream and a solid phenate (such as calcium phenate) is formed. The aqueous mixture of water and calcium phenate is passed through a filter 15 and the solids are removed. Clean water 16 is metered for pH, adjusted to a neutral pH as necessary, and is returned for use as make up water for new binder. Removed solids are either disposed of or are returned to the mixing tank to treat a subsequent batch of process water

In alternative embodiments the calcium hydroxide is replaced or supplemented with another alkaline earth metal salt such as calcium chloride, calcium nitrate, calcium sulfate, magnesium chloride, etc. As with the calcium hydroxide, the alternative salt binds with the solubilized resin and forms an insoluble salt which can be removed by filtration. This occurs when phenolic hydrogen is exchanged for calcium (or other salt ion), creating insoluble calcium phenate.

Similarly, in alternative embodiments the sodium hydroxide may be supplemented or replaced with another strong base, such as another alkali metal hydroxide, although cost factors typically favor sodium hydroxide. The sodium hydroxide used in the invention may be provided as a powder, or it may be an aqueous solution.

As to the amounts of sodium hydroxide and calcium hydroxide that must be added, sodium hydroxide (or other strong base) is preferably added in an amount sufficient to raise the pH of the process water to a pH greater than 11. More preferably, sodium hydroxide is added in an amount sufficient to raise the pH of the process water to a pH greater than 12, and most preferably to a pH of about 13. The amounts of sodium hydroxide required to do this will vary depending on the pH of the process stream being treated. Appropriate amounts can be determined by persons skilled in the art without undue experimentation. In certain preferred embodiments about 10 lbs. of 50% aqueous sodium hydroxide is added to about 100 lbs. of process stream water.

The alkaline earth metal salt (e.g., calcium hydroxide) is preferably added in an amount sufficient to convert all of the solubilized phenolic compounds to insoluble phenate. This too will depend on the nature of the process stream being treated, and appropriate amounts can be determined by persons skilled in the art without undue experimentation. In certain preferred embodiments about 10 lbs. of calcium hydroxide is used to treat about 100 lbs. of process stream water.

In the preferred embodiments the ratio of aqueous sodium hydroxide to calcium salt ranges from about 1:2 to about 2:1, with a ratio of about 1:1 being most preferred. As indicated above, these ratios refer to the relative amounts of 50% aqueous NaOH to 100% powdered Ca(OH)₂. In other embodiments 40:60 to 60:40 ratios of NaOH (50% aqueous solution) to Ca(OH)₂ are used.

In some preferred embodiments the filtered solids are recycled and reused to treat a subsequent charge of wastewater. When the filtered solids are reused, they may be used in conjunction with some new calcium salt and some new sodium hydroxide. Preferably, about 50-90% of the calcium salt used to treat a subsequent batch is recycled material, and about 10-50% of the calcium salt is new material. For example, about 100 lbs. of filtered process water can be treated with 16 lbs. of recycled filtrate (typically comprising calcium phenate and calcium hydroxide), 2 lbs. of new calcium hydroxide, and 2 lbs. of new sodium hydroxide to bring the pH back up to about 13. When this procedure is followed, recycled materials are preferably used.

The methods described above are effective for removing significant amounts of solubilized solids. In some embodiments, about 60% of the solubilized solids are removed. In other embodiments, more than 80% of the solubilized solids are removed. The process stream water that remains is accordingly substantially free of undesirable, solubilized solids.

Reference will now be made to specific examples using the processes described above. It is to be understood that the examples are provided to more completely describe preferred embodiments, and that no limitation to the scope of the invention is intended thereby.

### EXAMPLE 1

### Recovery of Solubilized Solids from Fiberglass Insulation Process Stream

A phenol-formaldehyde resin binder is prepared by mixing the resin with water, and subsequently adding ammonium sulfate, urea, silane, and optionally ammonia according to the following formula:

Resin solution—15%

Ammonium sulfate—5%

Urea—5%

Silane—3%

Ammonia—2%,

Water—70%.

The aqueous binder is promptly moved from the make-up tank to a dispersal zone where it is dispersed with an additional 10% water onto molten glass fibers. The binder cools and coats the glass, with approximately 15% of the binder remaining on the coated fibers. The remaining 85% of the binder is collected as run-off, and is filtered to remove dirt and other solids before being passed to a mixing tank for treatment to remove solubilized solids.

At the mixing tank, 100 lbs. of filtered process water is mixed with 10 lbs. of 50% aqueous NaOH and 10 lbs. of Ca(OH)₂ powder. Ammonia is released from the solution, and is bubbled through a NaHSO₄ acid scrub. The aqueous phase is passed to a filter where the solids are collected and the clean water is returned to be reused as make-up water for subsequent batches of binder.

Of the collected solids, about 20% are preferably disposed of, and about 80% are recycled to treat subsequent batches of wastewater. Accordingly, about 80% of the collected solids are added back to the mixing tank along with about 2 lbs. of aqueous (50%) NaOH and about 2 lbs. of Ca(OH)₂ powder to treat another 100 lbs. (about 10 gal.) of filtered water.

### EXAMPLE 2

### Calculation of Total Solids Extracted

A 5% binder solution is made containing about 0.35% solubilized solids. The solution is heated to about 110 F. and sodium hydroxide is added to bring the pH up to about 13. Calcium hydroxide is then added and the precipitate is removed by filtering. The cleaned water is determined to have about 0.066% solids remaining. Accordingly, about 81% of the solubilized solids have been removed.

While the invention has been illustrated and described in detail in the drawings and foregoing description, the same is to be considered as illustrative and not restrictive in character, it being understood that only the preferred embodiment has been shown and described and that all changes and modifications that come within the spirit of the invention are desired to be protected.

What is claimed is:

1. In a method of making fiberglass insulation material by contacting molten glass fibers with an aqueous phenol-formaldehyde resin binder to form coated fiberglass, accumulating and curing the coated fiberglass, and disposing of the unused aqueous phenol-formaldehyde resin binder, the improvement comprising:
(a) contacting a first portion of the unused aqueous phenol-formaldehyde resin binder with sodium hydroxide to liberate free ammonia,
(b) directing the liberated ammonia to a scrubber,
(c) contacting said first portion of the unused aqueous phenol-formaldehyde resin binder with calcium hydroxide to form insoluble calcium phenate,
(d) separating the insoluble calcium phenate and other solids from the aqueous components to provide substantially clean water, and
(e) recycling the substantially clean water as makeup water for new binder.

2. The method of claim 1 wherein said unused aqueous phenol-formaldehyde resin binder is contacted with sodium hydroxide in an amount sufficient to adjust the pH of the aqueous solution to about 13.

3. The method of claim 1 wherein at least a portion of said insoluble calcium phenate and other solids is recycled to contact a second portion of unused aqueous phenol-formaldehyde resin binder and to form a second portion of insoluble calcium phenate and other solids.

4. The method of claim 3 wherein said second portion of unused aqueous phenol-formaldehyde resin binder is contacted with recycled insoluble calcium phenate and other solids and with fresh calcium hydroxide.

5. The method of claim 3 wherein said second portion of unused aqueous phenol-formaldehyde resin binder is contacted with recycled insoluble calcium phenate and other solids, with fresh calcium hydroxide, and with fresh sodium hydroxide.

6. The method of claim 3 wherein said second portion of unused aqueous phenol-formaldehyde resin binder is contacted with about 80% of said insoluble calcium phenate and other solids, about 10% fresh calcium hydroxide, about 5% fresh sodium hydroxide, and about 5% water.

7. The method of claim 1 wherein said sodium hydroxide is an aqueous solution of sodium hydroxide.

8. A method for removing contaminants from an aqueous process stream comprising phenol-formaldehyde resin and ammonium hydroxide, said method comprising:
(a) mixing an alkali metal hydroxide with the aqueous stream to:
(i) raise the pH to about 13,
(ii) replace ammonium ions in the ammonium hydroxide with alkali metal ions, and
(iii) liberate free ammonia;
(b) mixing an alkaline earth metal salt with the aqueous stream to contact the phenol-formaldehyde resin and form an insoluble alkaline earth metal phenate; and
(c) filtering out the insoluble phenate.

9. The method of claim 8 wherein said alkali metal hydroxide is sodium hydroxide.

10. The method of claim 8 wherein said alkali metal hydroxide is potassium hydroxide.

11. The method of claim 8 wherein said alkali metal hydroxide is lithium hydroxide.

12. The method of claim 8 wherein said alkaline earth metal salt is a calcium salt.

13. The method of claim 12 wherein said calcium salt is calcium chloride.

14. The method of claim 12 wherein said calcium salt is calcium nitrate.

15. The method of claim 12 wherein said calcium salt is calcium sulfate.

16. The method of claim 12 wherein said calcium salt is calcium acetate.

17. The method of claim 8 wherein said alkaline earth metal salt is a magnesium salt.

18. The method of claim 17 wherein said calcium salt is magnesium chloride.

19. The method of claim 17 wherein said calcium salt is magnesium nitrate.

20. The method of claim 17 wherein said calcium salt is magnesium sulfate.

21. The method of claim 17 wherein said calcium salt is magnesium acetate.
